(19) United States
(12) Patent Application Publication
(10) Pub. No.: US 2017/0106793 A1
(43) Pub. Date: Apr. 20, 2017

(54) VEHICLE LIGHTING SYSTEM WITH DYNAMIC BEAM PATTERN

(71) Applicant: Ford Global Technologies, LLC, Dearborn, MI (US)

(72) Inventors: Arun Kumar, Farmington Hills, MI (US); Richard Joseph Michaels, III, Kailua, HI (US); Donald Paul Bilger, Livonia, MI (US); Edward R. Golden, Pinckney, MI (US)

(73) Assignee: Ford Global Technologies, LLC

(21) Appl. No.: 14/886,353

(22) Filed: Oct. 19, 2015

(51) Int. Cl. B60Q 9/00; B60Q 1/00; B60R 1/00; B60Q 1/48

(52) U.S. Cl. CPC B60Q 9/005; B60Q 1/482; B60Q 1/48; B60Q 1/0023; B60R 1/00; B60Q 2400/50

(57) ABSTRACT

A vehicle lighting system is provided herein. The vehicle lighting system includes an electronic adaptive drive beam system having a light source, a projection lens, and a digital micromirror device attached to a substrate. The lighting system further includes a camera. A controller is configured to determine a target parking space and initiate the electronic adaptive drive beam to continually outline the boundary thereof.

### FIELD OF THE INVENTION

The present disclosure generally relates to vehicle lighting systems, and more particularly, to an exterior lamp system generating a plurality of dynamic beam patterns.

### BACKGROUND OF THE INVENTION

Vehicle headlamp systems employing a plurality of beam patterns offer a unique and attractive viewing experience. It is therefore desired to implement a plurality of dynamic beam patterns in automotive vehicles for various lighting applications and vehicle functions.

### SUMMARY OF THE INVENTION

According to one aspect of the present disclosure, a vehicle lighting system is disclosed. The lighting system includes a first electronic adaptive drive beam system having a light source, a projection lens, and a digital micromirror device attached to a substrate. A camera is configured to capture images proximate the vehicle. A controller is configured to determine a target parking space from the captured images and initiate the first electronic adaptive drive beam to continually outline a boundary of the space.

According to another aspect of the present disclosure, a lighting system for a vehicle is disclosed. The lighting system includes an electronic adaptive drive beam system including a projection assembly configured to illuminate an area proximate a vehicle. A remote keyless entry apparatus is in communication with the electronic adaptive drive beam system. A transmitter is associated with the remote keyless entry apparatus. The electronic adaptive drive beam system projects one of a plurality of images based on a state of the transmitter.

According to yet another aspect of the present disclosure, a vehicle lighting system is disclosed. The lighting system includes a first adaptive drive beam system disposed within a front portion of a vehicle. A second adaptive drive beam system is disposed in a rear portion of the vehicle. A first camera is disposed proximately to the front portion. A second camera is disposed proximately to the rear portion. A controller is configured to determine a movement direction of the vehicle. The controller initiates the first adaptive drive beam system when the vehicle moves in a forward direction and initiates the second adaptive drive beam system when the vehicle moves in a rearward direction.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 illustrates a front perspective view of a vehicle having an electronic adaptive drive beam (eADB) system mounted on the front, according to one embodiment;

FIG. 2 is a perspective view of a rear portion of the vehicle having an eADB system mounted on the rear, according to one embodiment;

FIG. 3 exemplarily illustrates a portion of a digital micromirror device (DMD) of the eADB system having a light source directed towards the digital micromirror device;

FIG. 4 is a block diagram of the vehicle and the eADB system, according to one embodiment;

FIG. 5 illustrates a portion of the DMD with a first micromirror oriented in an on-state and a second micromirror oriented in an off-state;

FIG. 6A is a conceptual view illustrating a light reflection path of the DMD in a digital light processor (DLP) optical system with the first exemplary micromirror in the on-state;

FIG. 6B is a conceptual view illustrating a light reflection path of the DMD in the DLP optical system with the first exemplary micromirror in the transition-state;

FIG. 6C is a conceptual view illustrating a light reflection path of the DMD in the DLP optical system with the first exemplary micromirror in the off-state;

FIG. 7 is a perspective view of a portion of the components of the eADB system in space with a plurality of additional lighting devices therein, according to one embodiment;

FIG. 8A is a perspective view of the vehicle with a forward portion thereof facing a targeted space and the eADB system continuously outlining the targeted space, according to one embodiment;

FIG. 8B is a perspective view of the vehicle with the forward portion thereof facing the targeted space and the eADB system continuously outlining the targeted space and continuously directing the vehicle towards a central location within the targeted space, according to one embodiment;

FIG. 9A is a perspective view of a vehicle with a rear portion thereof facing the targeted space and the eADB system continuously outlining the targeted space, according to one embodiment;

FIG. 9B is a perspective view of a vehicle with the rearward portion thereof facing the targeted space and the eADB system continuously outlining the targeted space and continuously directing the vehicle towards the central location within the targeted space, according to one embodiment;

FIG. 10A is a perspective view of the vehicle rearwardly disposed in a targeted space;

FIG. 10B is a perspective view of the vehicle rearwardly disposed in a targeted space and an incoming occupant thereof disposed at a first distance from the vehicle causing the eADB system to illuminate a first image on a portion of the ground proximate the vehicle;

FIG. 10C is a perspective view of the vehicle rearwardly disposed in a targeted space and the incoming occupant thereof disposed at a second distance from the vehicle causing the eADB system to illuminate a second image on the portion of the ground proximate the vehicle;

FIG. 10D is a perspective view of the vehicle rearwardly disposed in the targeted space and the incoming occupant thereof disposed at a third distance from the vehicle causing the eADB system to is a perspective view of a third image on the portion of the ground proximate the vehicle;

FIG. 11A is a perspective view of the vehicle forwardly disposed within the targeted space;

FIG. 11B is a perspective view of the vehicle forwardly disposed within the targeted space and an incoming occupant thereof disposed at first distance from the vehicle thereby causing the eADB system to illuminate the ground proximately located to the vehicle;

FIG. 11C is a perspective view of the vehicle forwardly disposed within the targeted space and an incoming occupant thereof dispose at a second distance from the vehicle thereby causing the eADB system to illuminate the ground proximately located to the vehicle;

FIG. 12A is a perspective view of the vehicle approaching a target space within a garage;

FIG. 12B is a perspective view of the eADB system projecting a first image onto the ground within the garage forwardly of the vehicle and a second image onto a vertical wall of the garage simultaneously; and

FIG. 12C is a perspective view of the eADB system projecting a first image onto the ground within the garage forwardly of the vehicle and a continuous second image to assist in placement of the vehicle within the garage onto a vertical wall of the garage simultaneously.

### DETAILED DESCRIPTION OF THE PREFERRED EMBODIMENTS

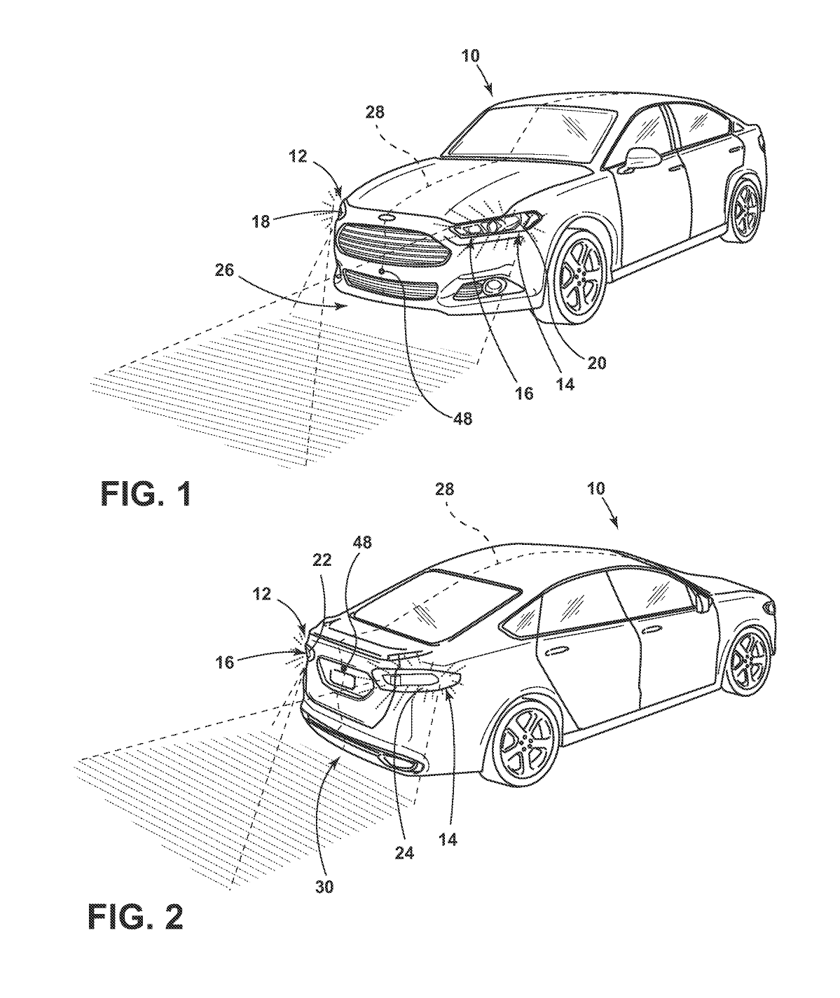

For purposes of description herein, the terms “upper,” “lower,” “right,” “left,” “rear,” “front,” “vertical,” “horizontal,” and derivatives thereof shall relate to the disclosure as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As required, detailed embodiments of the present disclosure are disclosed herein. However, it is to be understood that the disclosed embodiments are merely exemplary of the disclosure that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The following disclosure describes a vehicle lighting system having an electronic adaptive drive beam system that includes a projection system. The electronic adaptive drive beam system communicates with a sensing system, such as a camera, and when initiated, dynamically and/or continuously confers vehicle information and assistance to the driver of the vehicle.

Referring to FIGS. 1-2, a front view and a rear view, respectively, of a vehicle 10 having an electronic adaptive drive beam (eADB) system 12 is illustrated. The eADB system 12 may be disposed within any exterior lighting assembly 14 on the vehicle 10, or may be an independent assembly. Moreover, the eADB system 12 may include at least one projection assembly 16 therein. As illustrated in FIGS. 1-2, the vehicle 10 includes first and second front lighting assemblies 18, 20 and first and second rear lighting assemblies 22, 24. The first and second front lighting assemblies 18, 20 are installed in a front portion 26 of the vehicle 10 on either side of a longitudinal centerline 28 of the vehicle 10 to form a vehicle headlamp system. As illustrated in FIG. 2, the first and second rear lighting assemblies 22, 24 are installed on opposing sides of the vehicle centerline 28 on a rear portion 30 of the vehicle 10 to form a taillamp assembly on the vehicle 10. A sensing system, such as a camera 48, is disposed on the vehicle 10 and is oriented in a similar direction as the eADB system 12. More particularly, the sensing system may be used in conjunction with the eADB system 12 to determine which beam pattern to project from the eADB system 12.

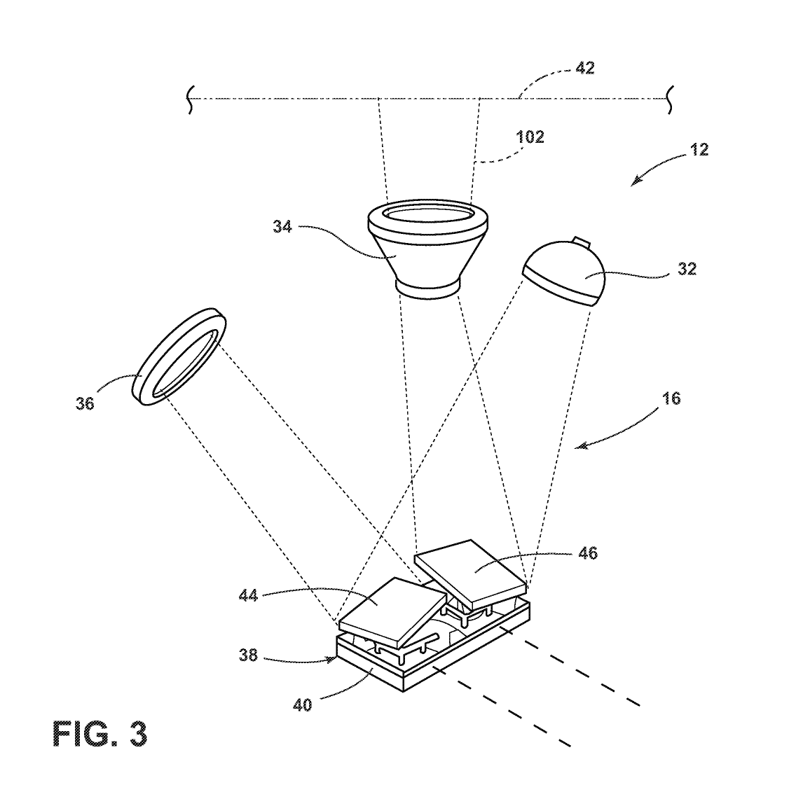

Referring to FIG. 3, each projection assembly includes a light source 32, a projection lens 34, a light absorber 36, a digital micromirror device (DMD) 38 disposed on a substrate 40, and a screen 42 to project light (or lighted image) onto. The DMD 38 is but one example of a spatial light modulator that may be used and it should be appreciated that any of a number and/or type of spatial light modulators may be used.

The eADB system 12 is configured to project light outwardly from the vehicle 10 into an exterior space. The projection assembly 16 may also be configured to project vehicle information outwardly from the vehicle 10. According to one embodiment, the light source 32 directs light towards the DMD 38. For example, the DMD 38 may be a digital light processor (DLP) light processing chip, which is a digital micromirror device that modulates micromirrors 44, 46, or pixels, at a very high rate of speed. The DMD 38 is a micro-electromechanical device that may include an array of hundreds of thousands of tilting digital micromirrors 44, 46 or pixels that are configured to project or deflect light to create a desired predefined beam pattern 102. From each micromirror's transition or resting state, the micromirrors 44, 46 may be actively tilted, for example, to a positive or negative angle corresponding to an “on” state and an “off” state. It will be appreciated, however, that any selectively controlled multiple-reflecting element may be substituted.

Light from the light source 32 is directed to the DMD's 38 “active area” whereupon it is reflected off the micromirrors 44, 46 and through a lens 34 for displaying images. The DMD 38 reflects the light from the light source 32 in a predefined beam pattern 102 to a lens 34 for projection outwardly from the vehicle 10 to continuously outline an object and/or targeted location. The projection assembly 16 may also generate a plurality of beams sequentially to create animated images for conferring vehicle information to an occupant and/or onlooker of the vehicle 10.

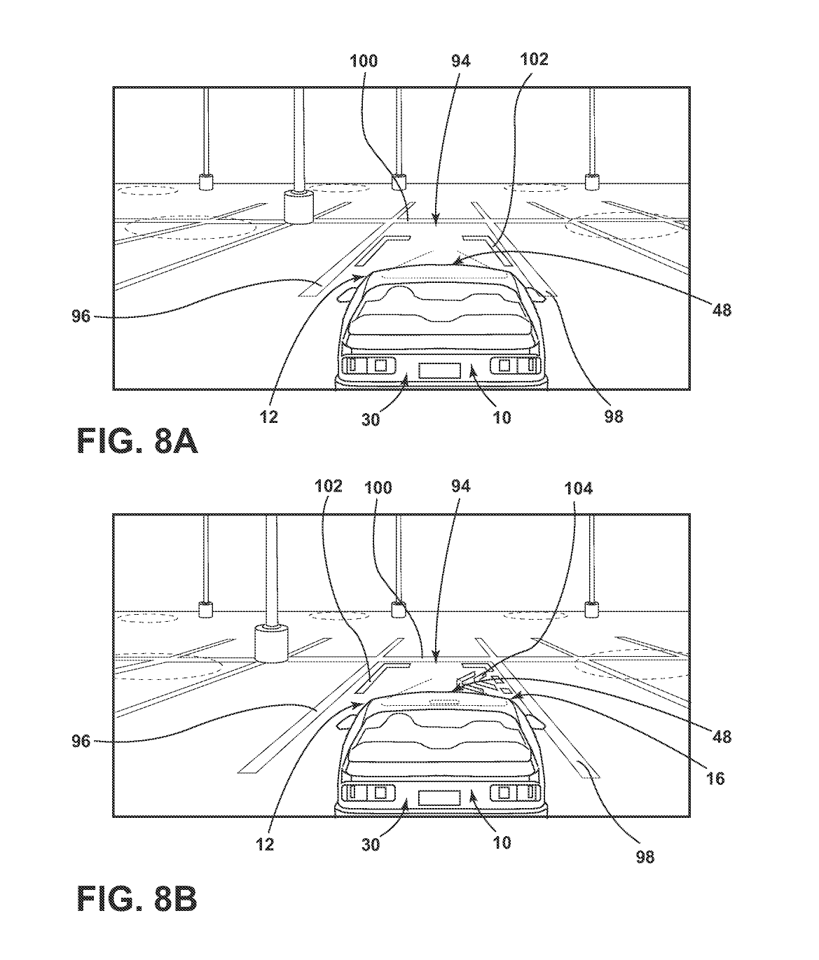

According to one embodiment, a plurality of predefined beam patterns 102 sequentially project to illuminate a targeted space, such as a parking space 94 (FIG. 8A), and/or a targeted object. The sequential illumination of predefined beam patterns 102 may maintain a constant illumination pattern on the target space and/or object as the vehicle 10 moves in position. Alternatively, the sequential illumination of predefined beam patterns 102 may alert an occupant outside of the vehicle 10 of the vehicle location. Alternatively still, a plurality of images may be sequentially illuminated such that the images appear animated, or to be moving.

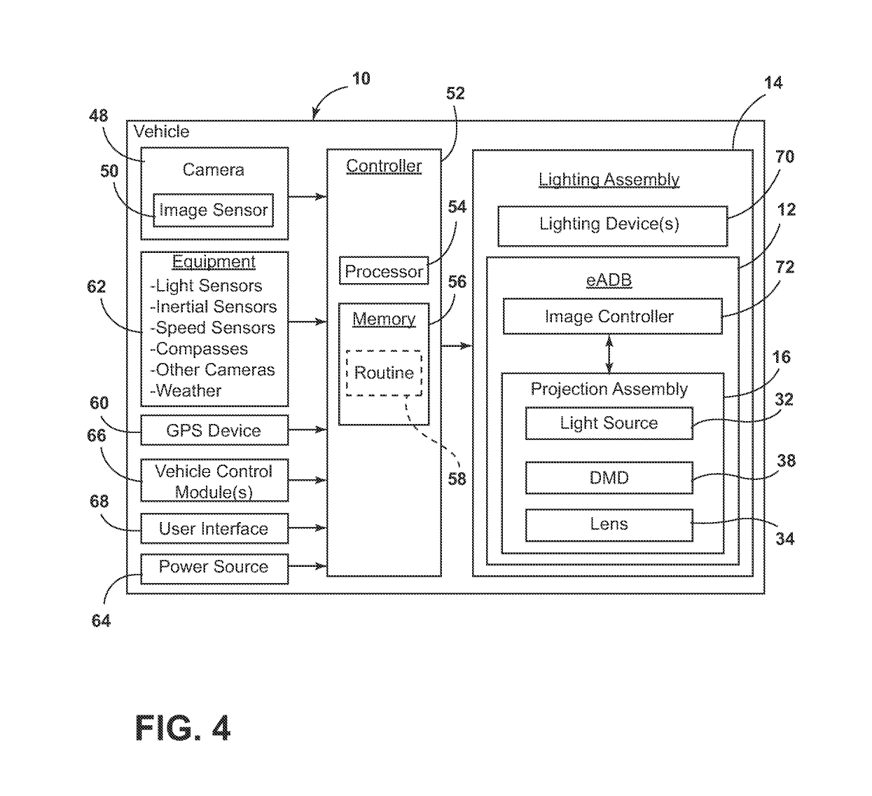

Referring to FIG. 4, a block diagram of the vehicle 10 having the eADB system 12, according to one embodiment, is illustrated. The camera 48 having an image sensor 50 that captures light and converts it into image data is disposed within the vehicle 10. The camera 48 can be mounted to any exterior portion of the vehicle 10 in which the eADB system 12 may be aimed. In one embodiment, the camera 48 and eADB system 12 are disposed on a front portion 26 (FIG. 1) of the vehicle 10 such that an image may be projected forwardly of the vehicle 10 based on vehicle characteristics that are sensed by the camera 48.

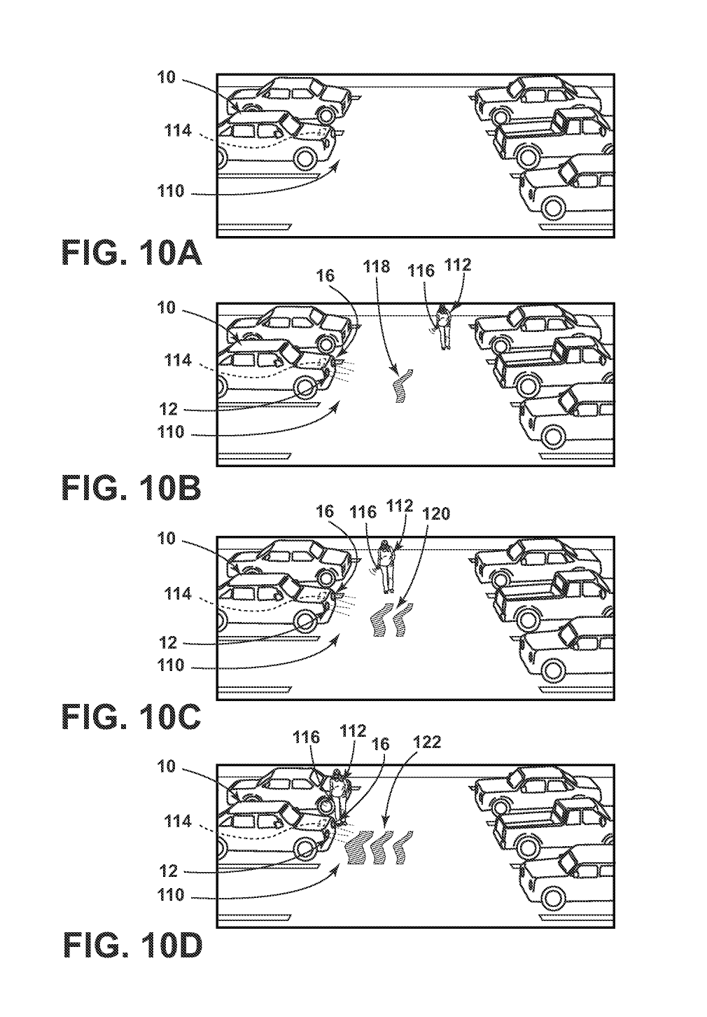

The vehicle 10 further includes a controller 52 that may be integrated with the camera 48 or located external thereto. The controller 52 can include circuitry such as a processor 54 and memory 56. A routine 58 for object and/or target detection can be stored in the memory 56 and is executed by the processor 54. In one embodiment, the controller 52 is configured to determine a target parking space 94 (FIG. 8A) and outline the boundary thereof. By knowing how the target space 94 should appear in a captured image, the controller 52 can analyze image data received from the camera 48 and direct the eADB system 12 to project a predefined beam pattern 102 (FIG. 8A) in a desired location. Alternatively, the eADB system 12 may illuminate an image on the ground 110 (FIG. 10A) proximate the vehicle 10 when the vehicle engine is in the off position and an incoming occupant is approaching the vehicle 10, as will be described below.

With respect to the illustrated embodiment, the controller 52 can also communicate with a positioning device 60, shown as a GPS enabled device, to receive input related to the geographical location of the vehicle 10. The positioning device 60 can be any suitable device capable of communicating with the controller 52. In one embodiment, the positioning device 60 is an onboard device such as, but not limited to, a Human Machine Interface (HMI). Since light conditions may vary depending on one's geographical location, the controller 52 can give consideration to the locational input supplied by the positioning device 60 in deciding whether an adjustment to the camera 48 and/or intensity of light projected from the eADB system 12 is needed.

In addition to the abovementioned inputs, the controller 52 may receive input from one or more equipment 62 located on the vehicle 10, which includes, but is not limited to, light sensors, speed sensors, inertial sensors, directional compasses, and/or other cameras, which can be provided in front, rear, and side facing configurations. By leveraging some or all of the equipment 62 with other devices and inputs described previously, the controller 52 can determine the orientation of the vehicle 10 relative to an object and/or target detection.

Additionally, since light conditions may also vary depending on the current time, date, and weather conditions, the controller 52 can additionally consider whether an adjustment to the eADB system 12 is needed. For example, the light intensity in Florida. during a clear summer afternoon will generally be higher than the light intensity in Michigan during an overcast summer morning. Thus, by making this type of information known to the controller 52, the controller 52 can predict certain characteristics related to the light captured by the image sensor 50 of the camera 48 and adjust the image capture settings of the camera 48 and/or eADB system 12 accordingly. Per the previously given example, if a vehicle 10 is located in Florida, the controller 52 may choose to decrease the intensity of light emitted from the eADB system 12 whereas the controller 52 may choose to increase the intensity of light emitted from the eADB system 12 if the vehicle 10 is located in Michigan. It is contemplated that the controller 52 can receive the time and date information via the positioning device 60, a portable electronic device, the electronic control module (ECM) of the vehicle 10, or any other suitable means. The weather information may be supplied to the controller 52 via an application running on a portable electronic device or an onboard device (e.g. HMI), or any other suitable means.

According to one embodiment, the eADB system 12 is configured to compensate for changing light conditions caused when the additional vehicle lighting devices 70 are activated. When the lighting device is activated, the lighting device may project light upon the imaged scene, thereby causing a sudden change in lighting conditions. If unaccounted for, the eADB system 12 may experience difficulty tracking the desired object and/or target, thus the eADB system 12 may adjust light intensity to compensate for such conditions.

According to one embodiment, the controller 52 may also provide electrical power to the eADB system 12 via a power source 64 located onboard the vehicle 10. In addition, the controller 52 may be configured to control the eADB system 12 based on feedback received from one or more vehicle control modules 66 such as, but not limited to, a body control module, engine control module, steering control module, brake control module, the like, or a combination thereof. By controlling the light emitted from the eADB system 12, the eADB system 12 may illuminate in a variety of colors and/or patterns to provide an aesthetic appearance, or may provide vehicle information to an intended observer. For example, when the eADB system 12 is illuminated, the eADB system 12 may assist the driver of the vehicle 10 in parking of the vehicle 10 within a targeted space 94 (FIG. 8A). Alternatively, the eADB system 12 may also assist a soon to be occupant of the vehicle 10 in locating the vehicle 10 through illumination of images proximate the vehicle 10 as the occupant approached the vehicle 10.

In another embodiment, the eADB system 12 may include a user interface 68. The user interface 68 may be configured such that a user may control functions and/or usability characteristics of the eADB system 12.

The controller 52 communicates with the lighting assembly 14 disposed on the vehicle that includes the eADB system 12. The controller 52 may modify the intensity of the light provided from the lighting assembly 14 by pulse-width modulation or current control. In some embodiments, the controller 52 may be configured to adjust a color of the emitted light by sending control signals to adjust an intensity or energy output level of the light source 32. The lighting assembly 14 may include vehicle lighting devices 70 including, but not limited to, headlights, fog lights, turn signals, markers, taillights, brake lights, supplemental lights, and any other forms of vehicle lighting.

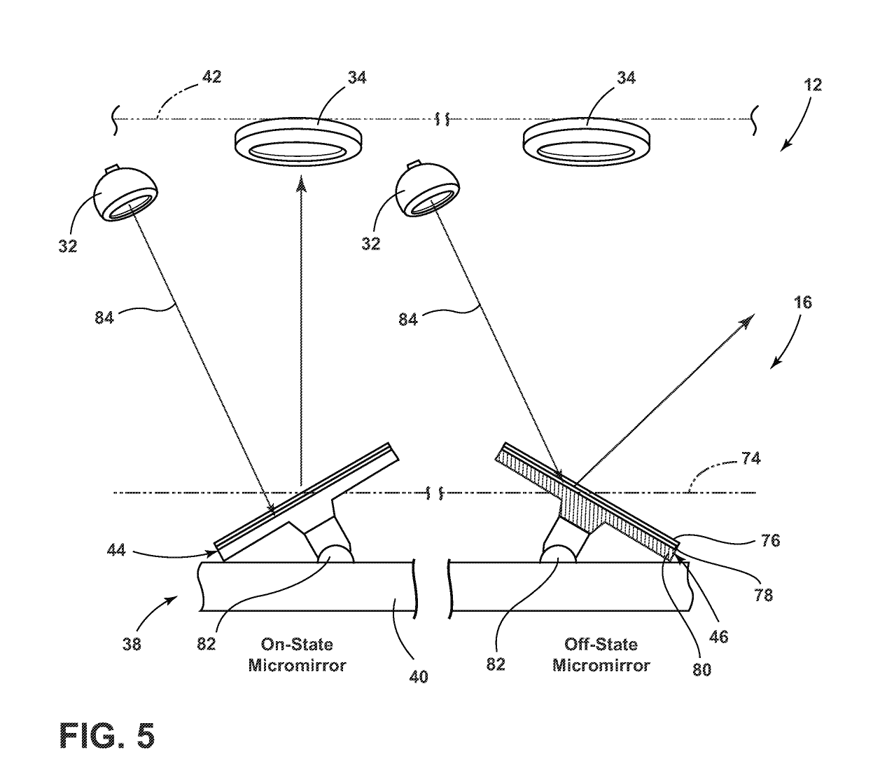

The lighting assembly 14 further includes the eADB system 12. The eADB system 12 may include an image controller 72 that stores a plurality of predetermined beam patterns 102 (FIG. 8A). The patterns contain the information for the positions of individual micromirrors 44, 46 (FIG. 5) on the DMD 38 within the projection assembly 16. The patterns are accessed when necessary depending on lighting and driving conditions. As described above, a variety of driver and sensor inputs may be used to determine which beam pattern 102 should be provided to the DMD 38 for projection by the eADB system 12. For example, steering angle, vehicle speed, light sensor input, driver inputs, etc. can all be used to determine the beam pattern 102 to be projected. The image controller 72 is used to communicate data from the vehicle controller 52 to the image controller 72, and subsequently to the projection assembly 16.

The image controller 72 communicates the selected beam pattern 102 and sends the pattern to the projection assembly 16 where the micromirrors 44, 46 are adjusted accordingly. The light source 32 is illuminated so that it emits light towards the DMD 38. The micromirrors 44, 46 that are in the on-state position reflect light outwardly through the lens 34. The result is the projection of a beam pattern 102 that optimizes the driver's visibility based on the surrounding environment and/or driving conditions. Accordingly, the eADB system 12 activates beam patterns 102 as they are needed depending on the driving situation, visibility needs and conditions, vehicle parameters, driver inputs, etc.

Referring to FIG. 5, a pair of micromirrors 44, 46 in the DMD 38 is exemplarily shown. Each micromirror 44 pixel is movable between a transition position in which light 84 is projected and a position other than transition in which light 84 is deflected away. A combination of strategically positioned pixels creates a desired beam pattern 102. Each micromirror 44 is movable about a pivot point 82 to move each respective micromirror 44 between an on-state, a transition state, and an off-state. According to one embodiment, the micromirrors 44 may rotate plus or minus ten (10) degrees from the neutral axis 74 as each micromirror 44 is moved between each state. The micromirrors 44 in the array are positioned in a combination of the three states to create the desired beam pattern 102.

With further reference to FIG. 5, the DMD 38 may include a plurality of micromirrors 44 constructed of three metal layers 76, 78, 80 disposed on the substrate 40 constructed from any practicable material, such as silicon. Each micromirror 44 may include a top layer 76, a middle layer 78, and a bottom layer 80. The three metal layers 76, 78, 80 are situated over the substrate 40, which may further include an integrated circuit (not shown), which provides electrical commands and signals. The top layer 76 includes a pixel mirror that resides over the middle layer 78 and bottom layer 80. Each micromirror 44 within the array may rotate on the pivot point 82 to rotate and tilt accordingly. Consequently, as the micromirror 44 rotates and tilts, it dictates the angle, direction, and magnitude that light 84 will be reflected off each respective micromirror 44. As illustrated in FIG. 3, micromirror 44 is rotated such that light 84 reflected therefrom are directed through the lens 34 and towards a screen 42. Micromirror 46 is rotated such that light 84 is directed therefrom towards the light absorber 36. Additional information regarding implementation of DMD technology within a vehicle and beam pattern can be found in U.S. Pat. No. 6,497,503, entitled “HEADLAMP SYSTEM WITH SELECTABLE BEAM PATTERN,” issued Dec. 24, 2002, the entire disclosure of which is incorporated herein by reference.

The light source 32 may include one or more lenses, LEDs, lasers, ambient light sources, or other light sources for generating and focusing the light 84 emitted from the light source 32. The light source 32 can include any suitable number of light sources appropriate for generating light 84 for transmission to the DMD 38.

The projection assembly 16 may also include one or more lenses 34 and lens support structures for focusing and projecting light 84 from the DMD 38 to the screen 42. The screen 42 can be any image field. The lens 34 may be made of a number of known transparent or semitransparent materials of flat or non-flat surfaces for the display of images and video in the projection assembly 16.

When the projection assembly 16 operates, the light source 32 directs visible light 84 to the active area of the DMD 38. The micromirrors 44, 46 on the active area of the DMD 38 create an image and reflect that image through the projection assembly 16 during the on-state of the DMD 38. The projection assembly 16 projects the image from the DMD 38 onto the screen 42. In this manner, the projection assembly 16 displays images and/or video on the screen 42.

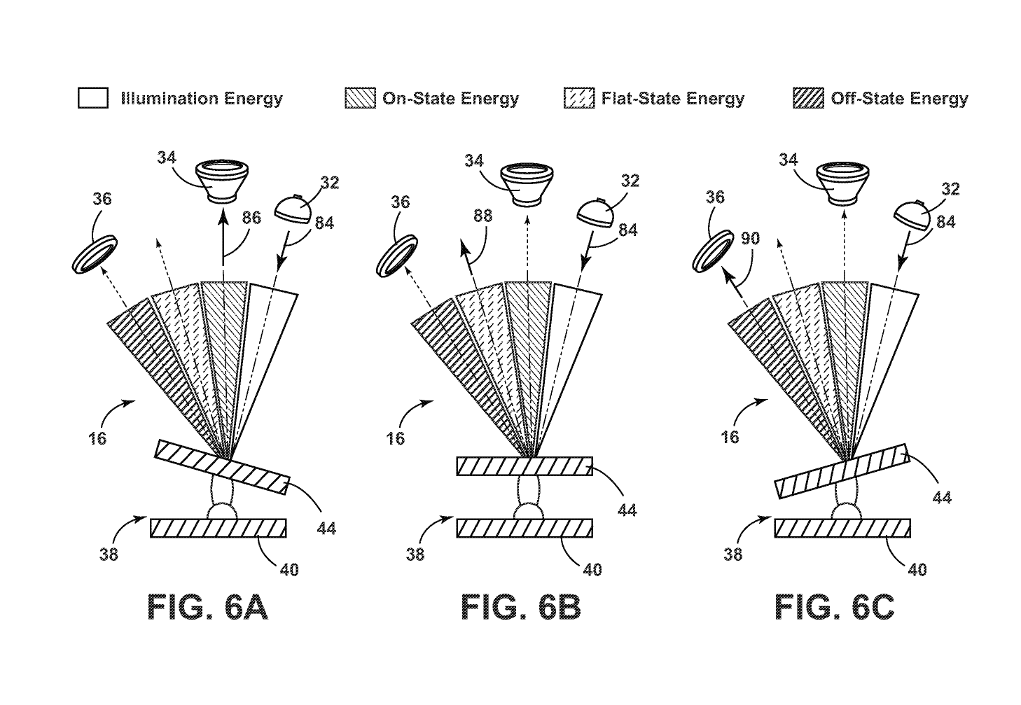

Referring to FIGS. 6A-6C, the DMD 38 reflects light 84 in the form of an on-state 86 or an off-state 90 according to a control signal input from a controller or other device on the outside. The on-state 86 or off-state 90 is changed in its path by a prism and projected to the outside via the projection lens 34. In detail, when needed, the DMD 38 reflects an input signal in the form of an on-state 86 or an off-state 90. When the input signal is reflected in the form of the on-state 86, the DMD 38 may realize a white screen 42. When the input signal is reflected in the form of the off-state 90, the DMD 38 may realize a black screen 42. There can exist a reflection angle of the DMD 38 in an on-state 86, a reflection angle of the DMD 38 in an off-state 90, and an intermediate angle between them. This is because the DMD 38 realizes the on-state 86 and the off-state 90 by physically rotating mirrors of the DMD 38. Therefore, a transition state 88, which is illustrated in FIG. 6B, may be generated when transitioning from the on-state 86 to the off-state 90, and when transmitting from the off-state 90 to the on-state 86.

As illustrated in FIG. 6A, when the micromirrors 44 of the DMD 38 rotate to a predetermined angle, DMD 38 emitted from the light source 32 is incident to the projection lens 34 when the light 84 is in the on-state 86. As illustrated in FIG. 6B, when the DMD 38 transitions from the on-state 86 to the off-state 90 or vice versa, the mirrors of the DMD 38 that reflect light 84 may go through an intermediate angle while the mirrors change between an angle corresponding to the on-state 86 and an angle corresponding to the off-state 90. As illustrated in FIG. 6C, light emitted from the light source 32 is incident to the light absorber 36 when the micromirror 44 is in the off-state 90. Through altering the positions of the array of micromirrors 44, a plurality of beam patterns 102 may be created by the projection assembly 16 in response to one or more vehicle characteristics.

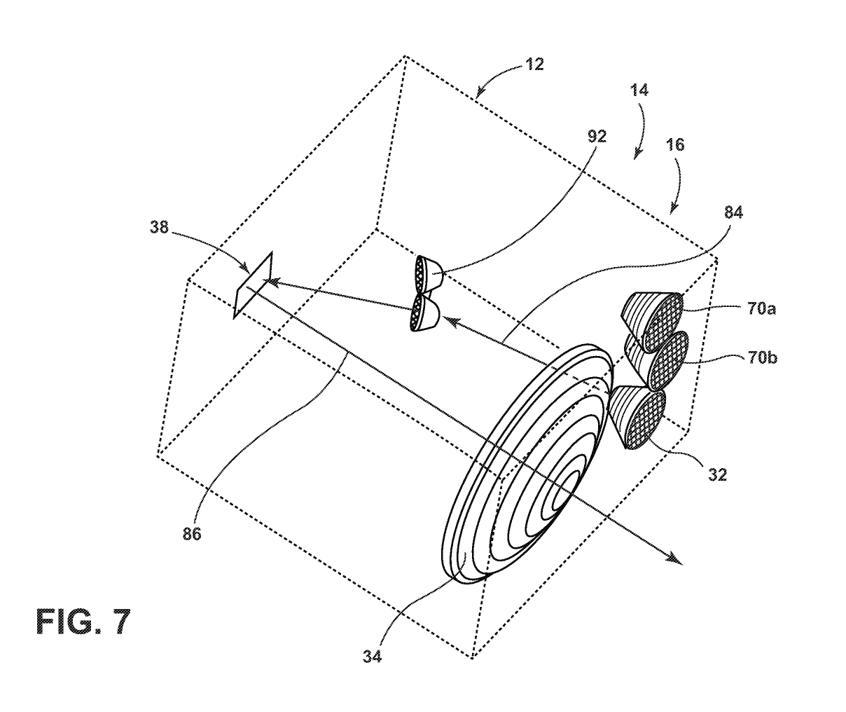

Referring to FIG. 7, packaging constraints on the vehicle 10 may dictate the arrangement of the continuous projection assembly 16. Accordingly, illumination optics 92 may be utilized in combination with the DMD 38 to orient these elements with respect to the light source 32. FIG. 7 shows one possible arrangement, but one skilled in the art is capable of using a multitude of configurations to achieve the best possible configuration as defined by the packaging constraints for the continuous projection assembly 16. As illustrated in FIG. 7, the light source 32 emits light 84 rearwardly towards the optics 92. Light is then redirected towards the DMD 38. The micromirrors 44 that are in the on-state 86 then direct the light towards the lens 34 which directs the light outwardly.

With further reference to FIG. 7, additional lighting devices 70a, 70b may be disposed within the lighting assembly 14. According to one embodiment, the lighting devices 70a, 70b may be configured to produce high and low beam patterns for the vehicle 10 if the lighting assembly 14 is disposed on the front portion 26 (FIG. 1) of the vehicle 10. Additional lighting devices may be disposed proximately to the illustrated lighting devices 70a, 70b and configured to operate for any reason, such as, utilization as a turn signal, fog lamp, running light, etc. Likewise, the lighting devices may be configured as reverse lights, brake lights, running lights, etc. if disposed on the rear portion 30 (FIG. 1) of the vehicle 10.

Referring to FIGS. 8A-8B, the vehicle 10 employing the eADB system 12 is illustrated, according to one embodiment. As illustrated, the vehicle 10 approaches a predefined target space 94. The predefined target space 94 may include a pair of longitudinally extending painted lines 96, 98 and a transversely extending latitudinal line 100 connecting the longitudinally extending lines 96, 98. It will be appreciated, however, that the target space 94 may be any position in which the vehicle 10 may be disposed and the eADB system 12 and/or the camera 48 may monitor the vehicle's surroundings for any other features or objects.

As illustrated in FIGS. 8A-8B, the camera images the operating environment while the vehicle 10 travels at a slow rate of speed towards the target location 94 and the vehicle controller 52 (FIG. 4) analyzes the captured images to detect the parking space 94 and its position in relation to the vehicle 10. While the vehicle 10 is still moving, the controller 52 determines whether any valid spaces are present in which the vehicle 10 may be disposed in. As defined herein, a valid space is one that is bounded by contiguous lane markers and is presently unoccupied by another vehicle 10 or other object. In addition, for a space to be valid, it should have a sufficient slot length and slot width to accommodate at least a portion of the vehicle 10 if not the entirety. In determining whether a space is valid, the controller 52 may process information provided from any input, the imaging system, and the known dimensions of the vehicle 10.

Once one or more valid spaces have been determined, the driver may select a target space 94 in which to place the vehicle 10. According to one embodiment, the driver selects the target space 94 via facing the vehicle 10 towards the target space 94. According to an alternate embodiment, the composite image of the parking spaces 94 may be displayed on a HMI, such as a touchscreen display, that may visually differentiate valid spaces from invalid spaces, such as those occupied by other vehicles 10. Specifically, the predefined pattern 102 may be projected from the eADB system 12 into the space and the driver may select the target space 94 through driving towards the space or choosing the space through the user interface 68 (FIG. 4) within the vehicle 10. For instance, the driver may select space as the target space 94 by touching a corresponding box on the user interface 68.

Once the target space 94 has been selected, the image controller 72 (FIG. 4) uses image data from the camera 48 to generate a predefined continuously updated projected beam pattern 102 forwardly, or rearwardly, of the vehicle 10. As used herein, continuously updated may be defined as a system that changes the projected image gradually as any variable(s) change in value. The changes may range in time of completion from hundreds of times per second to multiple times per minute. As exemplarily shown in FIG. 8A, the continuous projected beam pattern 102 outlines an area forwardly of the vehicle 10 and within the parking space 94. The continuous projected beam pattern 102 may assist the operator of the vehicle 10 in centering the vehicle 10 within the parking space 94. The determination of the steering trajectory may be based on information received from the equipment 62 (FIG. 4), imaging system, GPS system, and known dimensions of the vehicle 10. For example, information received from the imaging system and/or the equipment 62 may be used to identify the relative position and orientation of the vehicle 10 with respect to the target space 94. As the parking maneuver is underway, information received from the imaging system and/or the equipment 62 may be used to calculate where the vehicle 10 is located relative to the target space 94. Additional sensors such as wheel sensors, steering wheel sensors, and the like, may also be used to determine the relative position and heading of the vehicle 10 with respect to the target space 94.

As illustrated in FIG. 8B, the projection assembly 16 may continuously and/or dynamically assist a driver of the vehicle 10 for central placement of the vehicle 10 within the parking space 94 by continuously updating the projected outline of the targeted space 94. For example, the projections may be updated at any practicable frame frequency. Accordingly, if the vehicle 10 is off-centered in relation to the parking space 94, the projection assembly 16 may illuminate sequential arrows directing the driver of the vehicle 10 of a recommended direction for central placement within the target space 94. Accordingly, a first projected beam pattern 102 may outline the parking space 94. Simultaneously, a second projected beam pattern 104 may continuously direct the driver of the vehicle 10 of the proper movement of the vehicle 10. Moreover, each respective projected beam pattern 102 may have a unique color and/or frame frequency.

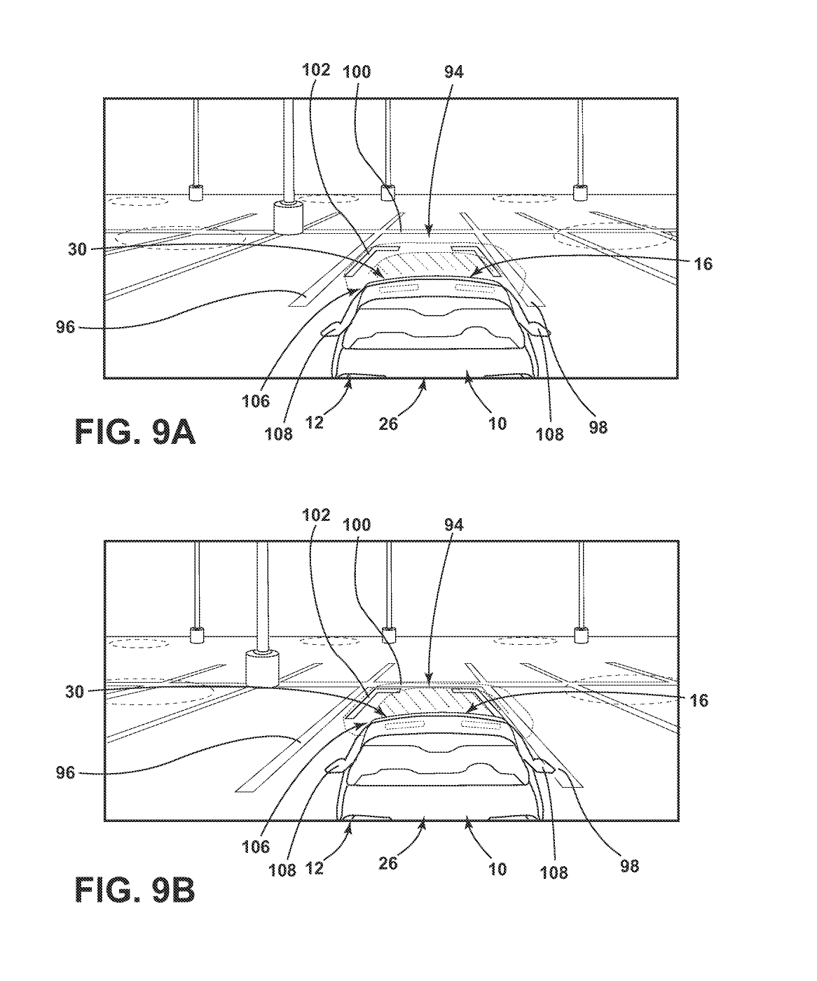

Referring to FIGS. 9A-9B, the projection assembly 16 may illuminate and/or outline a desired target zone for the vehicle 10 simultaneously with usage of the illumination assemblies on the rear portion 30 and/or front portion 26 of the vehicle 10. Accordingly, the projection assembly 16 may project the outline of the parking space 94 in a visually distinguishable color from the taillamps and/or headlamps.

According to one embodiment, a first eADB system 12 is disposed within the front portion 26 of the vehicle 10 and a second eADB system 106 is disposed in the rear portion 30 of the vehicle 10. Accordingly, the controller 52 may be configured to determine the movement direction of the vehicle 10 and initiate the respective projection assembly 16 that aligns therewith. For example, when the vehicle 10 transmission is placed in “drive,” the first eADB system 12 may be initiated. When the vehicle 10 transmission is placed in “reverse,” the second eADB system 106 may be initiated. Alternatively, when the vehicle 10 transmission is placed in “park,” the camera 48 may send images to the controller 52 intermittently. Based on the surrounding environment, the controller 52 may determine whether the vehicle 10 is forwardly or rearwardly disposed in a target space 94. Based on the orientation determination, the image controller 72 of the first and/or second eADB system 12, 106 may project image(s) away from the open side of the vehicle 10.

As illustrated in FIGS. 9A-9B, the vehicle 10 may be reversed into the parking space 94. Accordingly, the second eADB system 106 may be disposed on the rear portion 30 of the vehicle 10 and the projected beam pattern 102 may be projected at a width that is wider than the vehicle 10 such that the driver may be able to view the projected beam pattern 102 in a side view mirror 108 disposed on the vehicle 10. Moreover, the projected beam pattern 102 may incorporate symbols that are inverted such that the projected beam pattern 102 appears in a readable orientation to the driver after reflection off of the side view mirror 108.

Referring to FIGS. 10A-10D, the projection assembly 16 is configured to illuminate a portion of the ground 110 proximate the vehicle 10, according to one embodiment. When the vehicle 10 transmission is placed in “park,” a plurality of images may sequentially project onto the ground 110 as an occupant 112 of the vehicle 10 approaches the parked vehicle 10. According to one embodiment, a remote keyless entry (RKE) apparatus 114 mounted within the vehicle 10 communicates with the eADB system 12. A wireless key fob 116 and transmitter is associated with the RKE apparatus 114 and is identifiable by a unique frequency match to enable the fob 116 to transmit signals to the RKE apparatus 114 which are recognized by the RKE apparatus 114 as being valid for vehicle control functions.

The fob 116 includes a controller, which may be a processor based controls executing a control program stored in memory. One or more user input buttons are mounted on the housing of the fob 116. The buttons are associated with a particular vehicle function, such as locking or unlocking the vehicle doors and/or trunk or hatch, lowering the vehicle windows, remotely starting the vehicle engine, flashing the vehicle horns and/or lights, etc. Once the user depresses one of the buttons associated with the desired vehicle function that the user wishes to initiate, the control initiates the desired function. According to one embodiment, the depression of the button may cause the eADB system 12 to sequentially illuminate indicia on the ground 110 proximate the vehicle 10 to indicate the location of the vehicle 10. Alternatively, the RKE apparatus 114 may sense the incoming occupant's 112 distance from the vehicle 10 and initiate the illumination of the indicia on the ground once the incoming occupant 112 is within a predefined distance of the vehicle.

As illustrated in FIGS. 10A-10D, the RKE apparatus 114 within the vehicle 10 may be configured to monitor the distance between the key fob 116 and the vehicle 10. As the key fob 116 approaches predefined distances from the vehicle 10, images may be illuminated. For example, as shown in FIG. 10A, the projection assembly 16 may be placed in an off-state while the occupant 112 is sufficiently away from the vehicle 10. As illustrated in FIG. 10B, a first image 118, for example, a single arrow, may illuminate on the ground 110 as the occupant 112 approaches a first distance from the vehicle 10. As illustrated in FIG. 10C, once the occupant 112 reaches a second distance, less than the first distance, a second image 120, such as a pair of arrows, may be projected onto the ground 110. Likewise, as illustrated in FIG. 10D, a third image 122 may be projected as the occupant 112 continues to approach the vehicle 10 and the key fob 116 is disposed within a third distance that is less than the second distance. According to the embodiment shown in FIG. 10D, the third image 122 includes three arrows that are pointed towards the vehicle 10. Furthermore, the arrows may sequentially illuminate so as to further direct an incoming occupant 112 towards the vehicle 10. It will be appreciated, however, that the image(s) may be of any symbol oriented in any way. It will further be appreciated that any image may include a plurality of beam patterns that sequentially illuminate to create a continuous animated image.

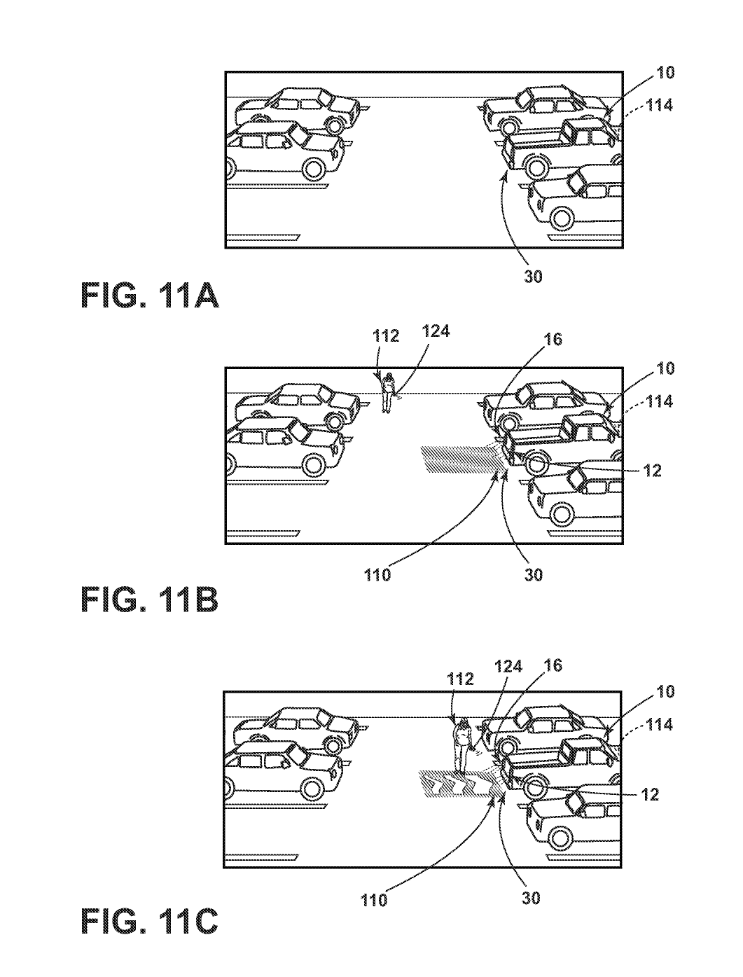

Referring to FIGS. 11A-11C, the eADB system 12 may additionally, or alternatively, be mounted on the rear portion 30 of the vehicle 10. As described in reference to 10A-10D, the eADB system 12 may sequentially illuminate images on the ground 110 the rear of the vehicle proximate for assistance in locating the vehicle 10. A portable electronic device 124 configured to wirelessly communicate with the RKE apparatus 114 mounted within the vehicle 10 such as a smartphone, tablet, and the like may be utilized for initiating the eADB system 12.

The eADB system 12, when disposed on the rear portion 30 of the vehicle 10 may also be configured to sense an object, such as a shopping cart, disposed proximately to the rear portion 30 of the vehicle 10. Such an object may signify that the occupant 112 has goods to load into the vehicle 10. Accordingly, the projection assembly 16 may illuminate the ground 110 and direct light rearwardly at the object simultaneously to help in loading the goods into the vehicle 10.

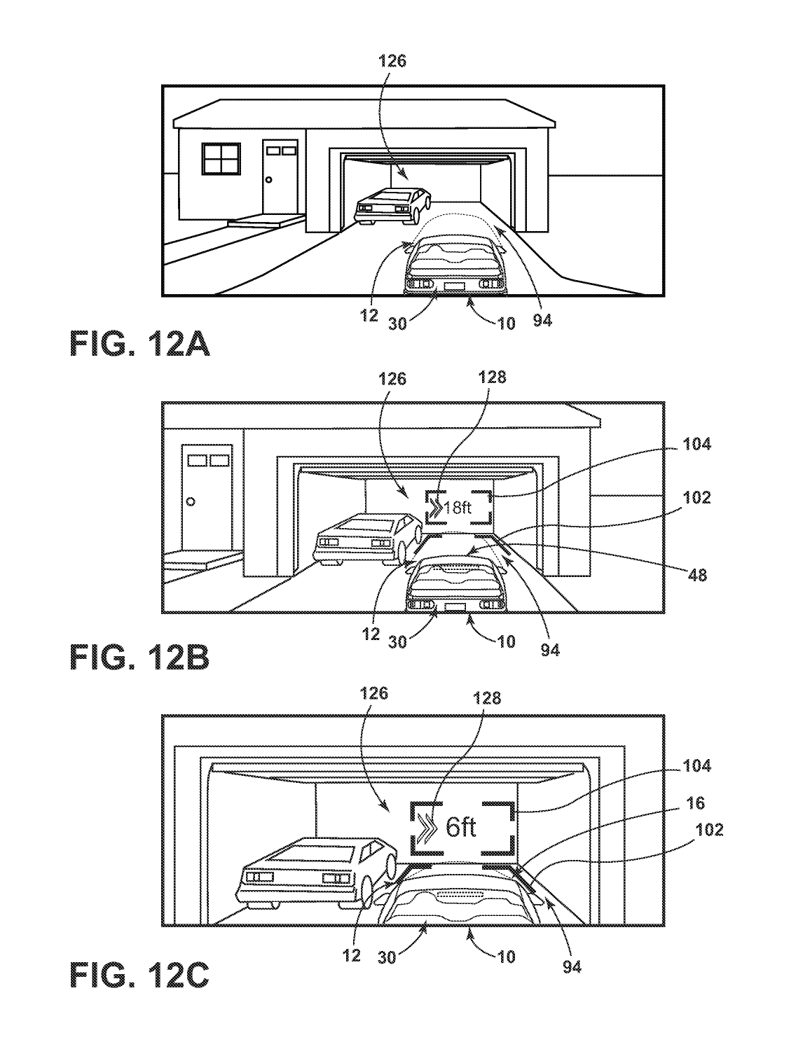

Referring to FIGS. 12A-12C, the eADB system 12, according to one embodiment, is illustrated on the front portion 26 of the vehicle 10 and is configured to assist in parking the vehicle 10 within a building, such as a garage 126. The eADB system 12 may continuously assist a driver into centrally locating the vehicle 10 within a targeted parking space 94 by projecting a plurality of beam patterns 102 sequentially to create an appearance that the image is moving (e.g., an animated image) and continuously changing with a change in the vehicle 10 and/or an occupant 112 thereof.

According to one embodiment, the controller 52 utilizes the camera 48 and a sensing system onboard the vehicle 10 to evaluate data supplied therefrom and signals a corresponding image forwardly of the vehicle 10. As illustrated, a first beam pattern 102 is generated on the ground 110 to outline the targeted parking space 94. A second beam pattern 104 is generated on the front, vertical wall of the garage 126. The second beam pattern 104 may further assist in centrally aligning the vehicle 10 within the target space 94 and/or indicate the distance between the wall and the vehicle 10. A third beam pattern 128 may supply directional recommendations for properly aligning the vehicle 10 within the targeted space 94.

Alternatively, images supplied by the camera 48 may be used for determining user information rather than additional sensors onboard the vehicle 10. Based on the images, the controller 52 may continuously determine the distance to the vehicle 10 travelling ahead and a part of its rear area suitable as a projection surface. The measured distance is compared to a minimum distance predetermined as a function of the speed of the vehicle 10 and if the minimum distance is undershot, the eADB system 12 may initiate the projection assembly 16 to project a warning signal.

Accordingly, a vehicle having an electronic adaptive drive beam system has been advantageously described herein. The eADB system provides various benefits including an efficient and cost-effective means to produce illumination that may provide vehicle information and/or may function as a distinct styling element that increases the refinement of a vehicle, or any other product that may have an eADB system disposed therein.

It is also important to note that the construction and arrangement of the elements of the disclosure as shown in the exemplary embodiments are illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown in multiple parts may be integrally formed, the operation of the interfaces may be reversed or otherwise varied, the length or width of the structures and/or members or connectors or other elements of the system may be varied, the nature or number of adjustment positions provided between the elements may be varied. It should be noted that the elements and/or assemblies of the system might be constructed from any of the wide variety of materials that provide sufficient strength or durability, in any of the wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle lighting system, comprising:
a first electronic adaptive drive beam system having a digital light processor attached to a substrate;
a camera configured to capture images proximate the vehicle; and
a controller configured to determine a target parking space from the captured images and initiate the first electronic adaptive drive beam to continually outline a boundary of the space.

2. The vehicle lighting system of claim 1, wherein the first electronic adaptive drive beam system is disposed within a headlamp assembly.

3. The vehicle lighting system of claim 1, wherein the first electronic adaptive drive beam system is disposed within a taillamp assembly.

4. The vehicle lighting system of claim 1, further comprising:
a second electronic adaptive drive beam system having a digital light processor attached to a substrate, wherein the first electronic adaptive drive beam system is disposed on a front portion of the vehicle and the second electronic adaptive drive beam system is disposed on a rear portion of the vehicle.

5. The vehicle lighting system of claim 1, wherein the first electronic adaptive drive beam system projects an image in a visually distinguishable color from a proximately located lighting device on an exterior portion of the vehicle.

6. The vehicle lighting system of claim 5, wherein the first electronic adaptive drive beam system is configured to compensate for changing light conditions caused when the lighting device is activated.

7. The vehicle lighting system of claim 2, wherein the first electronic adaptive drive beam system includes an image controller that uses image data from the camera to generate a predefined continuously updated projected beam pattern forwardly of the vehicle to continuously outline a target area forwardly of the vehicle.

8. A lighting system for a vehicle, comprising:
an electronic adaptive drive beam system including a projection assembly configured to illuminate an area proximate a vehicle;
a remote keyless entry apparatus in communication with the electronic adaptive drive beam system; and
a transmitter associated with the remote keyless entry apparatus, wherein the electronic adaptive drive beam system projects one of a plurality of images based on a state of the transmitter.

9. The lighting system for a vehicle of claim 8, wherein the remote keyless entry apparatus is configured to monitor a distance between the transmitter and the vehicle and the electronic adaptive drive beam system projects images therefrom as the transmitter is disposed within predefined distances from the vehicle.

10. The lighting system for a vehicle of claim 9, wherein the a first image illuminates on a ground surrounding the vehicle as the transmitter approaches a first distance from the vehicle and illuminates a second image as the transmitter reaches a second distance, less than the first distance from the vehicle.

11. The lighting system for a vehicle of claim 10, wherein the first and second images are differing numbers of arrows pointing towards the vehicle at varied distances from the vehicle.

12. The lighting system for a vehicle of claim 11, wherein the arrows sequentially illuminate to further assist in locating the vehicle.

13. The lighting system for a vehicle of claim 9, wherein the electronic adaptive drive beam system is disposed on a rear portion of the vehicle and configured to sense an object disposed proximately to the rear portion of the vehicle, and wherein the projection assembly illuminates a portion of ground proximate the vehicle and directs light rearwardly at the object simultaneously.

14. A vehicle lighting system, comprising:
a first adaptive drive beam system disposed within a front portion of a vehicle;
a second adaptive drive beam system disposed in a rear portion of the vehicle;
a first camera disposed proximately to the front portion;
a second camera disposed proximately to the rear portion; and
a controller configured to determine a movement direction of the vehicle, wherein the controller initiates the first adaptive drive beam system when the vehicle moves in a forward direction and initiates the second adaptive drive beam system when the vehicle moves in a rearward direction.

15. The vehicle lighting system of claim 14, wherein the first and second cameras intermittently sends images to the controller and the controller determines a forwardly or a rearwardly orientation of the vehicle in a target space.

16. The vehicle lighting system of claim 15, further comprising:
a first image controller within the first adaptive drive beam system; and
a second image controller within the second adaptive drive beam system, wherein the controller initiates the first or second image controller based on a vehicle orientation and the first or second adaptive drive beam system projects an image away from the open side of the vehicle.

17. The vehicle lighting system of claim 14, wherein the second adaptive drive beam system projects a beam pattern at a width that is wider than the vehicle.

18. The vehicle lighting system of claim 15, wherein the beam pattern incorporates inverted images such that the images appear in a readable orientation to a driver after reflection off of a mirror.

19. The vehicle lighting system of claim 14, wherein the first adaptive drive beam system projects a first beam pattern on a ground to outline a targeted parking space, a second beam pattern on a wall in front of the vehicle, and a third beam pattern configured to supply directional recommendations for properly aligning the vehicle within the targeted space.

20. The vehicle lighting system of claim 14, wherein the first adaptive drive beam system is initiated when an occupant approaches a front portion of the vehicle and the second adaptive drive beam system is initiated when the occupant approaches a rear portion of the vehicle.
